(19) United States
(12) Patent Application Publication
(10) Pub. No.: US 2013/0103409 A1
(43) Pub. Date: Apr. 25, 2013

(54) PROVIDING eFOLIOS

(71) Applicants: Peter K. Malkin, Ardsley, NY (US); Jacquelyn A. Martino, Cold Spring, NY (US); Juerg von Kaenel, Fitzroy (AU); Seetharami R. Seelam, Yorktown Heights, NY (US)

(72) Inventors: Peter K. Malkin, Ardsley, NY (US); Jacquelyn A. Martino, Cold Spring, NY (US); Juerg von Kaenel, Fitzroy (AU); Seetharami R. Seelam, Yorktown Heights, NY (US)

(73) Assignee: INTERNATIONAL BUSINESS MACHINES CORPORATION, Armonk, NY (US)

(21) Appl. No.: 13/278,842

(22) Filed: Oct. 21, 2011

(51) Int. Cl. G06Q 40/00

(52) U.S. Cl. 705/1.1

(57) ABSTRACT

Providing an electronic itemized list of purchases made by a user, in one aspect, may include receiving data associated with the user and one or more purchases made by the user, storing the data in an itemized purchase database, enabling access to the data, and providing an itemized list of purchases based on the data in accordance with one or more query criteria.

### FIELD

The present application relates generally to computers, and computer applications, and more particularly to computer application that track and provide information about user's purchases.

### BACKGROUND

A consumer's itemized purchase receipts only persist if they keep the point of sale receipts provided by vendors. As a result, if a user wants to analyze their buying/spending trends they need to manually input itemized data into spreadsheets or other personal finance tools. Further, such methods are not linked to any service opportunities where the user can leverage their data on consumption patterns and influence. While electronic receipts may be provided by vendors, those receipts still need to be put together by the consumer in order to perform his or her buying/spending trend analyses.

### BRIEF SUMMARY

A method and system for providing an electronic itemized list of purchases made by a user may be provided. The method, in one aspect, may include receiving data associated with the user and one or more purchases made by the user. The method may also include storing the data in an itemized purchase database. The method may further include enabling access to the data. The method may yet further include providing an itemized list of purchases based on the data in accordance with one or more query criteria.

A system of providing an electronic itemized list of purchases made by a user, in one aspect, may include a module operable to execute on a processor and receive data associated with the user and one or more purchases made by the user. A database module may be operable to store the data in an itemized purchase database. The module may be further operable to enable access to the data and provide an itemized list of purchases based on the data in accordance with one or more query criteria.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 is a block diagram illustrating a system for keeping track of purchase information.

FIGS. 2A and 2B are flow diagrams illustrating a methodology of the present disclosure in one embodiment.

FIG. 3 illustrates a schematic of an example computer or processing system that may implement the eFolio system in one embodiment of the present disclosure.

### DETAILED DESCRIPTION

A methodology is disclosed, which in one embodiment may automatically provide a user with a fully itemized list of all of the user's purchases, and for instance, provide categorized views of this itemized data on request. The purchaser's viewpoint may be placed at the center of transaction histories. For example, using financial instrument(s) like credit and debit cards, the purchaser can have a holistic view of the itemized expenses and use the aggregate of the data in consumer-driven ways such as collecting bids from vendors on the price of future purchases.

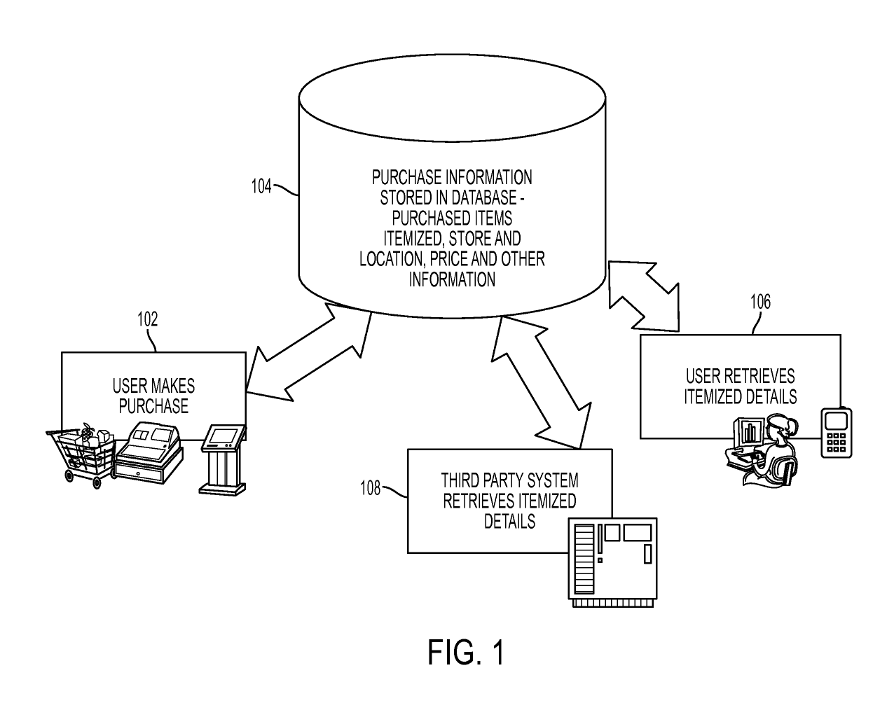

FIG. 1 is a block diagram illustrating a methodology of the present disclosure in one embodiment. A user may make one or more purchases as shown at 102. The purchases may be made with financial instrument such as debit and/or credit card or other pay mechanism.

The information about the one or more purchases may be transmitted to a database system as shown at 104. The transmission of the purchase data may be performed directly from a point of sale terminal or kiosk to a system that manages the database. In another aspect, such data may be transmitted from a system associated with the financial payment systems. The information may be itemized details of the purchase. The information may be stored in a database. Such database is referred to herein as user's itemized purchase database (IPDB).

At 106, the user may perform a variety of queries on the aggregated data for simple informational purchases. The user may utilize the purchase information for various purposes, for instance, future purchase strategies, personal financing strategies, and/or others. In one embodiment, a user may be given an account to the user's IPDB, for instance, with a user name and password. Upon proper authentication procedures for accessing the data, the user may retrieve the information. Any type of devices may be utilized to retrieve the information, for instance, from a user's mobile device such as a cellular phone, smartphone, and/or others, or from a conventional desktop computer, and/or others.

In another aspect, at 108, the database may be made accessible to one or more permitted third parties. Such third party may include businesses seeking opportunity for sales, establishing new stores, and others. One example use for the third party may be for services opportunities including getting bids on the user's future purchase power and influence.

The following describes example usage scenarios.

In one example scenario (scenario #1), User A shops at the ACMR Supermarket selecting, 2 gallons of milk, 3 boxes of pasta, and a gallon of ice cream. When she checks out, she pays using her Visa card. An itemized receipt of the purchases is automatically uploaded to the IPDB (Itemized Purchase Database). The data stored in the IPDB includes the type and number of items purchased as well as the price, date and location of the supermarket and name of supermarket. When User A gets home she queries the IPDB and retrieves a summary report of all the food she has purchased this month. This summary may include categorized lists of the items purchased (e.g., a list of the drinks, and desserts). Since itemized receipts are uploaded to the IPDB from all of the stores where User A buys food, she can obtain complete summaries—categorized ones—of all of her food-related expenses.

In another example scenario (scenario #2), the facts are the same as in scenario #1 above, but here the IPDB resides on User A′s mobile device. This IPDB may be backed up remotely and can be transferred to any new mobile device User A obtains.

Yet in another example scenario (scenario #3), the facts are the same as in scenario #2, but here, at a later time, User A goes to a liquor store to purchase some beer. The store scans User A's IPDB, learns that she has just purchased pasta, and so automatically suggests that User A also buy some red wine to go with pasta. In this aspect, the data may be used to benefit the liquor store also, for example, suggesting a wine the store is interested in selling. In order to persuade—and possibly earn some customer loyalty—the store offers her a significant discount if she purchases the wine within the next 15 minutes.

In another example scenario (scenario #4), the facts are similar to scenario #1, but here a convenience store chain, is deciding whether it should open a new store in a building which is located 2 blocks from where User A lives (or in the proximity of User A). To make this choice, the convenience store may explore the purchasing patterns of those who live close the proposed building, checking whether their consumption levels would support a new store.

Still yet another example scenario (scenario #5) may be like the scenario described in scenario #3, but related to multiple users, e.g., for household expenses. For instance, User A and User B have agreed to aggregate their data profiles. User B goes to the liquor store to purchase some beer, the store scans their shared IPDB and sees the household data shows a pasta purchase and automatically makes recommendation of a red wine with a possible loyalty discount.

Another scenario example (scenario #6) may have similar fact patterns to scenario #2 and scenario #3, but neither User A nor User B has gone to the liquor store. Rather, local wine vendors scan their IPDB and see the pasta purchase. A number of wine vendors “bid” for their business by pushing coupons for red wine to one or more of User A or User B′s mobile devices.

In yet another example scenario (scenario #7), the fact patterns may be similar to scenario #3, but relates to a friend's circle of purchases. Here the databases of the friends' circle need not be an aggregate in the details, but rather in the generalities of timing and trends. If the user permits access, vendors can analyze data of a friend circle and see who is the purchase influencer of given products and as a result the influencer may be given, e.g., loyalty benefits.

A system and method of the present disclosure may be described herein as “eFolio.” eFolio in one aspect, refers to an instance of one or more methods described here, one or more databases associated with the instance (e.g., Itemized Purchase Database (IPDB)), the communications and access relationships between: vendors/stores and the IPDB, users and the IPDB, and the third parties (e.g., stores, as in scenario #6, those that bid for business) and the IPDB.

In one aspect of the present disclosure, the individual owner of the eFolio has complete control over 1) the information that is collected, 2) over what is shared 3) with whom it is shared 4) when it is shared and 5) how it is shared. The methodologies of the present disclosure may leverage emerging privacy and security technologies to ensure that only the data the user allows access to can be retrieved or viewed.

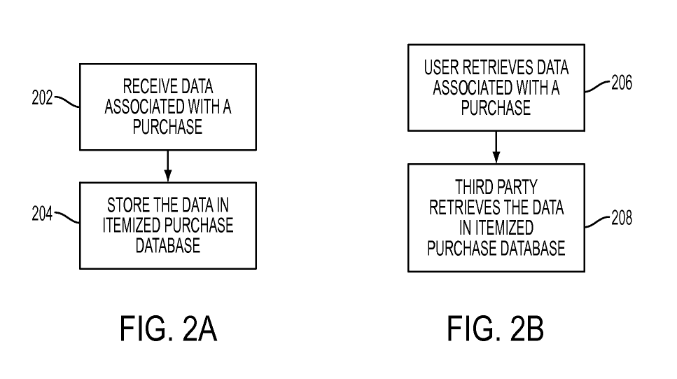

FIGS. 2A and 2B are flow diagrams illustrating a methodology of the present disclosure in one embodiment. Referring to FIG. 2A, at 202, data associated with user purchases are received at a system of the present disclosure. The data may include the user information, description of the item purchased by the user, price, store location, and other information about the purchase. At 204, the received data is stored.

FIG. 2B illustrates a methodology of the present disclosure in one embodiment, in which the stored data may be used. At 206, a user may retrieve the data from the itemized purchase database. A query may retrieve the itemized purchase data associated with the user by any desired category, for instance, by item types, price range, by dates (e.g., over a period or interval of time). At 208, a third party may access the IPDB and use the information to promote the third party sales or businesses.

As described above, eFolio's associated database(s) may include various itemized information relating to a purchase. For instance, in addition to the IPDB stored itemized purchase information described above, information such as, but not limited to, product specific information including a batch number and the source of the product, e.g., where the product is manufactured, grown, packaged, etc., may be also stored in the IPDB. An embodiment of a methodology of the present disclosure may include checking such data stored in the IPDB against the current status or alert raised on various products or services. For instance, the current available information or news on products such as food poisoning, product recalls may be matched against the itemized purchase data stored in the IPDB to determine if any one of the products or services purchased by the user is associated with current product recall or other alerts. If there is a match the eFolio of the present disclosure may alert the user (consumer). Matching of the current news/alerts against the data may be performed, for instance, by looking up one or more news databases, websites, and/or other information stores to determine which products or services have alerts raised or are being recalled (or the like), and querying the IPDB database for a match on those products. Other methodologies may be used to determine whether the products purchased by the user (whose information is stored in the IPDB) are associated with product recalls or other alerts. For instance, eFolio may include a subscription to one or more such news/alerts services which may push such information to eFolio, which then may trigger the matching to be performed in the IPDB database.

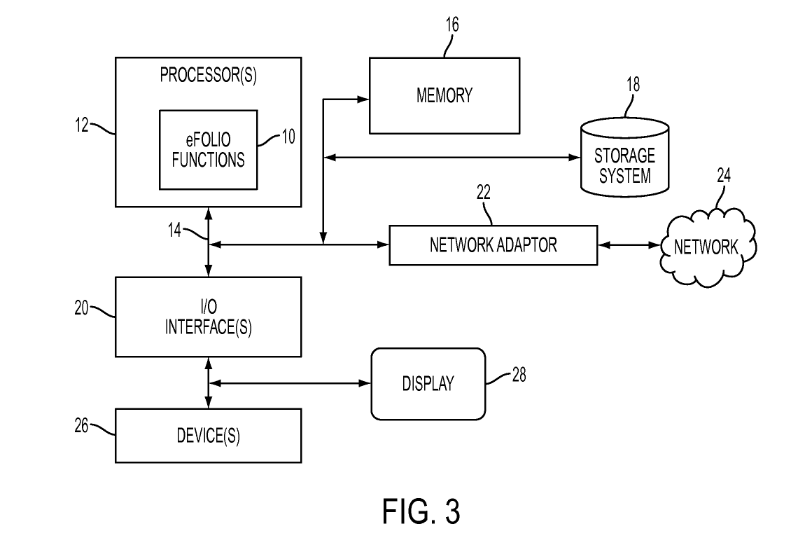

FIG. 3 illustrates a schematic of an example computer or processing system that may implement the eFolio system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 3 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include an eFolio module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

1. A method of providing an electronic itemized list of purchases made by a user, comprising:
receiving, by at least one processor, data associated with the user and one or more purchases made by the user;
storing, by the at least one processor, the data in an itemized purchase database;
enabling, by the at least one processor, access to the data;
providing, by the at least one processor, an itemized list of purchases based on the data in accordance with one or more query criteria:
subscribing, by the at least one processor, to current news for information push associated with one or more products or services or combinations thereof regarding at least whether the one or more products or services or combinations thereof are related to recalls, whether the one or more products or services or combinations thereof are related to food poisoning;
in response to receiving the current news, searching the itemized purchase database for said one or more products;
in response to finding said one or more products in the itemized purchase database, alerting the user.

2. The method of claim 1, wherein the data associated with the user and one or more purchases include user identifier, one or more purchased items and associated prices, and location of purchase.

3. The method of claim 1, further including:
enabling access to one or more third parties.

4. The method of claim 1, further including:
aggregating data associated with purchases made by a group of users.

5. The method of claim 1, wherein the one or more query criteria include item category.

6. The method of claim 1, wherein the one or more query criteria include period of time.

7. The method of claim 1, wherein the step of providing an itemized list of purchases based on the data in accordance with one or more query criteria includes transmitting the itemized list to a mobile device of the user in accordance with one or more query criteria.

8.-24. (canceled)

25. The method of claim 1, further comprising:
collecting one or more bids from one or more vendors on a price of an item in the itemized list of purchases.

26. The method of claim 1, further comprising:
enabling location determination for opening a new store based on the data stored in the itemized purchase database.
